(19) United States
(12) Patent Application Publication
(10) Pub. No.: US 2012/0030860 A1
(43) Pub. Date: Feb. 9, 2012

(54) Hat-cord combination, kit, and method of manufacture

(76) Inventor: John Lovitz, Wauconda, IL (US)

(21) Appl. No.: 13/317,058

(22) Filed: Oct. 7, 2011

Related U.S. Application Data
(63) Continuation-in-part of application No. 12/799,135, filed on Apr. 19, 2010.

(51) Int. Cl. A42B 1/24; B23P 11/00

(52) U.S. Cl. 2/209.13; 29/428

(57) ABSTRACT

A hat-cord assembly, kit, and method for manufacturing same provides users with a hat construction and a braided or weaved length of cord fastened thereto. The hat construction comprises a looped hat band or foliage ring, which band or ring comprises at least one aperture structure extending therethrough. The length of cord is preferably braided to provide both a decorative effect and an ample cord source when attached to the hat band or foliage ring. The cord preferably comprises thermally-liquefiable material and has opposed primary cord ends, which ends are insertable through the aperture structure and are thermally-liquefiable for respectively liquefying the primary cord ends at the aperture structure. The liquefied primary cord ends are thermally-solidifiable for fastening the primary cord ends to the hat band at the aperture structure.

### PRIOR HISTORY

This application is a Continuation-in-Part (CIP) patent application claiming the benefit of pending U.S. patent application Ser. No. 12/799,135, filed in the United States Patent and Trademark Office on 19 Apr. 2010, the specifications of which are hereby incorporated into this specification in their entirety by reference thereto.

### BACKGROUND OF THE INVENTION

1. Field of the Invention

The present invention generally relates to a (boonie) hat assembly, and more particularly, to a hat-cord combination for providing users with a decorative length of cord readily available and wearable upon the user's hat.

2. Description of Prior Art

U.S. Pat. No. 2,117,937 ('937 patent), which issued to Brownell, discloses a Knife Sheath. The '937 patent describes a sheath like body providing a pocket for the blade of a knife, a tongue formed on the body and rising therefrom, said tongue on the body and rising therefrom, said tongue having spaced parallel slots extending longitudinally therein, means including a loop extending through the slots for adjustment with respect to the tongue for receiving and gripping the handle of the knife, and a substantially arrowhead shaped flap formed on the means and having spaced parallel slots therein to receive the belt of the wearer of the sheath for slidably securing the flap to the belt, and means for detachably securing the flap to the tongue.

U.S. Pat. No. 4,803,745 ('745 patent), which issued to Izquierdo, discloses a Survival Knife Sheath. The '745 patent describes a knife sheath including a rear side defining an upwardly opening receptacle portion for downwardly receiving therein the blade of a survival knife and a front side defining a pair of side-by-side upwardly opening compartments with one of the compartments having a plurality of aerial flares stored therein and the other compartment defining an aerial flare supporting compartment in which the base end of one of the aerial flares may be removably retentatively supported.

The knife sheath of the '745 patent further defines a firing pin bore disposed immediately beneath and opening upward into the aforementioned other compartment and containing an upwardly spring biased firing pin therein for impact with a center primer portion of the base end of aerial flare retained in position thereabove: The sheath also includes an exteriorly slidably mounted trigger member operably connected to firing pin through a slot formed in the sheath and upon which downward manual digital pressure may be applied to downwardly retract the firing pin from an associated aerial flare for subsequent release and impact engagement with the flare primer.

U.S. Pat. No. 4,805,818 (118 patent), which issued to Harrison, discloses a Knife Sheath and Tool Device. The '818 patent describes a knife sheath device comprising a gripping or cutting type of tool such as a pair of pliers or wire cutters. The device includes a sheath pivotally mounted upon a back plate with the back plate and sheath cooperating to form and operate the tool. Portions of the tool are formed or attached to the sheath and also to the back plate, and the tool is operated by pivoting the sheath in relation to the back plate.

U.S. Pat. No. 4,805,819 ('819 patent), which issued to Collins, discloses a Sheath for a Retractable Knife. The '819 patent describe a sheath for housing a retractable knife both in its retracted or unretracted state provided with a pair of pockets, one adapted to receive the knife blade and a second adapted to receive the knife when the blade is housed within its handle, and additionally capable of being folded into a more compact form when housing a retracted knife.

U.S. Pat. No. 5,009,348 ('348 patent), which issued to Derkatz, discloses a Knife Sheath of Tough Flexible Material. The '348 patent describes a knife sheath comprising a back wall, a front wall attached at its periphery to said back wall to form a knife-receiving pouch, and a pair of laterally spaced slits in said front wall for receiving a wearer's belt, said slits being offset in the longitudinal direction, whereby when the wearer's belt is passed through said offset slits said pouch sits at a forward angle on the wearer's belt and snugly located on the wearer's hip and tucked in the belt.

U.S. Pat. No. 6,840,416, ('416 patent), which issued to Aberman, describes a Knife Sheath. The '416 patent describes a sheath for carrying a knife or blade comprising a scabbard attached to a carrying strap forming a loop through which a carrying junction such as a belt may be passed. The axis of the loop is generally aligned with a transverse axis perpendicular to an axis of gravity. The length of the scabbard includes a longitudinal axis generally angled with respect to the axis of gravity. The mouth of the scabbard is further angled with regard to the transverse axis. Each of the foregoing alignments allows a user to more easily and efficiently insert and remove a blade into the scabbard while carrying the sheath. The sheath is also provided with an inner shell disposed inside the scabbard, the inner shell having a plurality of lengthwise linear ridges for gripping the blade inside the shell.

United States Patent Application No. 2008/0250652, which was authored by Fellhoelter, describes a knife and sheath that includes a spring element as part of the handle with a pin that engages a slot in the sheath so as to lock the knife and sheath together. The knife and sheath are unlocked by biasing the spring element towards the center line of the knife, thereby disengaging the pin from the slot.

It is noted that in addition to knives, hats and other gear are commonly used in for outdoor activities. For example, a boonie hat, also known as a bush hat, is a form of wide-brim hat commonly used by military forces. Its design is similar to a bucket hat or fishing hat but with a stiffer brim. Often a fabric tape band of “branch loops” or “foliage ring” is sewn around the crown of the hat. This “foliage ring” is meant to hold additional vegetation or similar matter for camouflage purposes.

To those with extensive experience in outdoor and primitive camping scenarios, it should become apparent that there are situations that invariably arise in which one requires or could greatly benefit from additional cordage, but which cordage is not readily available with the supplies on hand. As a boonie hat may be readily worn in such situations, it becomes apparent that the extra cordage could also be attached to such a hat the hat via the foliage ring, thus having cordage available whenever the need arises.

After exhaustive development, it was found that weaving or braiding a cord and attaching it to a boonie type hat via apertures formed in the foliage ring afforded several additional feet of cordage with no interference to the hat. This additional cordage was invaluable for situations in which tent or tarp cords need to be replaced, emergency fishing line is needed (e.g. the cordage exemplified in this application comprise thinner strands which can be separated for this purpose), clothesline for drying, tying lean to shelters, and securing gear, for example.

It will be seen from an inspection of the prior art juxtaposed adjacent the foregoing conceptual bases that the prior art perceives a need for a hat-cord combination for providing users with a readily available source of cord, easily carried or worn around the crown of one's head and ornamentally or decoratively applied to a boonie hat or similar other head wear.

### SUMMARY OF THE INVENTION

Accordingly, it is a primary object of the present invention to provide certain means for carrying additional cordage attached to a boonie hat in a compact and easily accessible manner. The purpose of the additional cordage being attached to the hat allows the carrier to have approximately 44 feet (on a 25 to 27-inch hat band) of cordage available for both emergency and non-emergency situations. The unique weaving-braiding process of the cordage allows for various lengths of cordage based on the hat size being used.

To achieve these and other readily apparent objectives, the present invention essentially provides a hat-cord assembly or combination, a hat-cord assembly kit, and a method for manufacturing same such that users thereof are provided a (boonie type) hat and a readily accessible length of cord. The hat-cord combination according to the present invention thus comprises, in combination a hat assembly and a (braided) length or lengths of cord.

The hat assembly comprises a hat construction having a crown portion and a hat band or foliage ring, which foliage ring is periodically stitched widthwise along its length to portions of the crown portion of the hat thereby providing branch loops around which the cord length may be braided. The hat band further comprises at least one aperture structure extending therethrough, preferably at the posterior portion of the band, for providing an anchor aperture to which a cord terminus may be anchored.

The length of cord preferably comprises thermally-liquefiable material and has opposed primary cord ends, which primary cord ends are insertable through the aperture structure and are thermally-liquefiable for respectively liquefying the primary cord ends at the aperture structure. The liquefied primary cord ends are thermally-solidifiable for fastening or anchoring the primary cord ends to the band-based apertures (preferably outfitted with grommets). The hat-cord assembly or combination according to the present invention thus provides users with a hat construction in combination with end-fastened length(s) of cord.

### BRIEF DESCRIPTION OF THE DRAWINGS

Other features of my invention will become more evident from a consideration of the following brief description of patent drawings:

FIG. 1 is a top, anterior perspective view of the hat-cord combination assembly according to the present invention.

FIG. 2 is a top perspective view of a basic prior art (boonie) hat assembly outfitted with a foliage ring or hat band, which foliage ring comprises a series of undulating loops.

FIG. 3 is an enlarged fragmentary depiction of a posterior portion of the hat assembly otherwise depicted in FIG. 2, showing a pair of grommets inserted into the terminal ends of the foliage ring, which terminal ends are stitched to a posterior seam of a crown portion of the hat assembly.

FIG. 4 is a depiction of a grommet application device and a hat assembly, the grommet application device for applying grommets to the hat assembly substantially as depicted.

FIG. 5 is an enlarged fragmentary depiction of a posterior portion of the hat assembly according to the present invention depicting a first cord attaching arrangement with heat or thermal energy being directed into cord ends to heat-melt or thermally liquefy the cord ends at the grommet structures thereof.

FIG. 5(a) is an enlarged, fragmentary sectional view of a first cord-to-band, grommet-based junction site showing two cord strands inserted through a band aperture, one of which extends under the band and one of which is being heat melted or thermally liquefied.

FIG. 5(b) is an enlarged, fragmentary sectional view of a second cord-to-band, grommet-based junction site showing two cord strands inserted through a band-based, grommet-lined aperture, one of which extends under the band, and one of which has been heat melted or thermally liquefied and thermally solidified, the latter of which has parts broken away to depict otherwise hidden structure.

FIG. 5(c) is an enlarged, fragmentary sectional edge view of the cord-to-band, grommet-based junction site otherwise depicted in FIG. 5(b) showing a cord strand inserted through a band-based, grommet-lined aperture and having been thermally liquefied with thermal energy being directed out of the liquefied material for solidifying the liquefied material at the cord end and anchoring the cord end to the hat band.

FIG. 6 is a depiction of three cords, two of which cords are coiled at the lower end thereof and oppose a folded or undulated central cord.

FIG. 7 is a depiction of a braided cord assembly with parts broken away to show an inner folded cord structure according to the present invention.

FIG. 8 is a depiction of a braided cord assembly according to the present invention.

FIG. 9 is a first sequential enlarged fragmentary depiction of a posterior portion of the hat assembly showing (1) a first cord with melted terminus being directed inwardly at an upper grommet-lined aperture such that the melted terminus is exterior to the band, and (2) a second cord with melted terminus being directed outwardly at a lower grommet-lined aperture such that the melted terminus is interior to the band.

FIG. 10 is a second sequential enlarged fragmentary depiction of a posterior portion of the hat assembly showing otherwise depicted in FIG. 9 showing the first and second cords being looped and braided together about a looped section of the hat band or foliage ring of the hat assembly.

FIG. 11 is a diagrammatic depiction of a preferred cord-to-band arrangement showing a preferred method for braiding two cords together about the hat band or foliage ring of the hat assembly.

FIG. 12 is a top, posterior perspective view of the hat-cord combination assembly according to the present invention.

FIG. 13 is an enlarged, fragmentary depiction of a section of band length having a series of grommet-lined apertures formed therein with the left most grommet-lined aperture having a cord section length extending therethrough, which cord section length comprises a melted globule terminus and is outfitted with a C-shaped crimp clamp.

FIG. 13(a) is an enlarged, fragmentary depiction of a section of cord length outfitted with a C-shaped crimp clamp.

FIG. 13(b) is an enlarged transverse cross-sectional view of the cord length outfitted with a C-shaped crimp clamp as sectioned from FIG. 13(a).

FIG. 14 is an enlarged fragmentary diagrammatic sectional side view depiction of a melted globule cord terminus extending through a grommet-lined band-based aperture with C-shaped crimp clamp.

FIG. 14(a) is an enlarged fragmentary sectional view of a portion of the structures otherwise depicted in FIG. 14 to more clearly show structural relationships.

FIG. 15 is a top perspective view of a hat-cord combination kit according to the present invention showing a braided cord, a coiled cord length, and a (boonie type) hat element in (translucent) packaging.

FIG. 15(a) is a end elevational view of the hat-cord combination kit otherwise depicted in FIG. 15 showing the coiled cord length and hat element in (translucent) packaging.

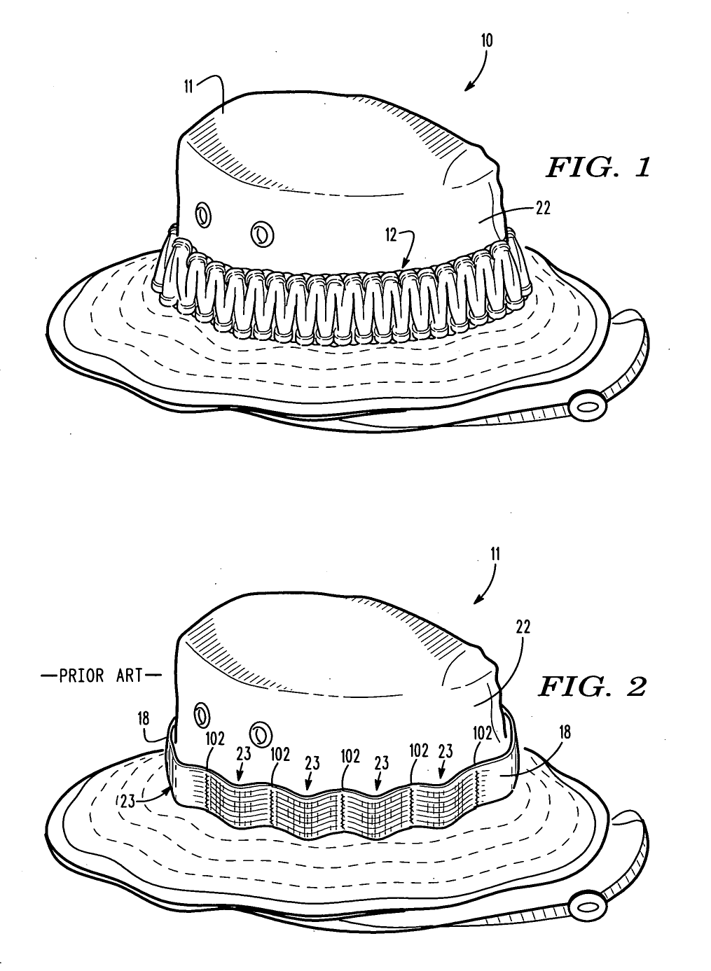

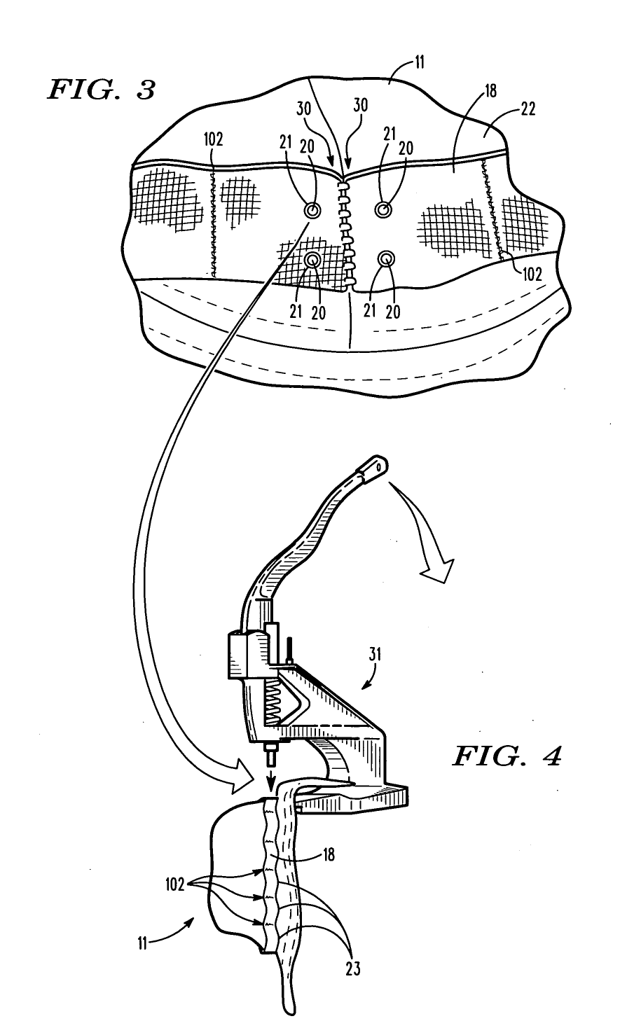

### DETAILED DESCRIPTION OF THE PREFERRED EMBODIMENT

Referring now to the drawings with more specificity, the present invention essentially provides a hat-cord combination 10 or utility gear assembly for providing users with a hat-cord combination 10 essentially comprising a hat construction as at 11 and an ornamentally or decoratively braided length of cord as at 12. The ornamentally braided cord 12 is attached or fastened to the hat construction 11 in a unique manner. Before being braided, the cord 12 is typically provided in various cord lengths 15 as specified by the user.

From a comparative inspection of the figures, the reader may note that the unbraided cord lengths 15 may be assembled such that an inner folded cord length 16 may be enveloped by an outer braided cord length 17, and together the length 16 and the length 17 may cooperably yield the ornamentally braided length of cord as at 12. The essential notion being addressed is to maximize the overall length of cord otherwise fastenable or outfittable upon the hat construction 11 for exemplary use in outdoor or survival type scenarios.

The preferred material construction of the cord 12 is that of so-called parachute cord otherwise known as paracord or 550 cord, which cord typically has a nylon or polymeric component. In this regard, it is noted that a key feature of the cord 12 (regardless of brand name or provider) is that it preferably comprises thermally-liquefiable material, which material once liquefied into a globule, may be re-solidified into an irregularly shaped globular anchor 14 to “weld” or anchor the cord ends 13 of the cord 12 to a hat band or foliage ring (as at 18) of the hat construction 11.

Notably, “nylon” is a generic designation for a family of synthetic polymeric materials known generically as polyamides first produced on in the 1930's by Wallace Carothers of E. I. du Pont de Nemours and Company (DuPont). As used in this application, the essential feature of the material is its thermoplastic attributes. In other words, a key aspect of the cord 15 is that the polymeric material liquefies when heated (i.e. thermally energized as at 100) and freezes to a hardened state when cooled (i.e. thermally de-energized as at 101) sufficiently.

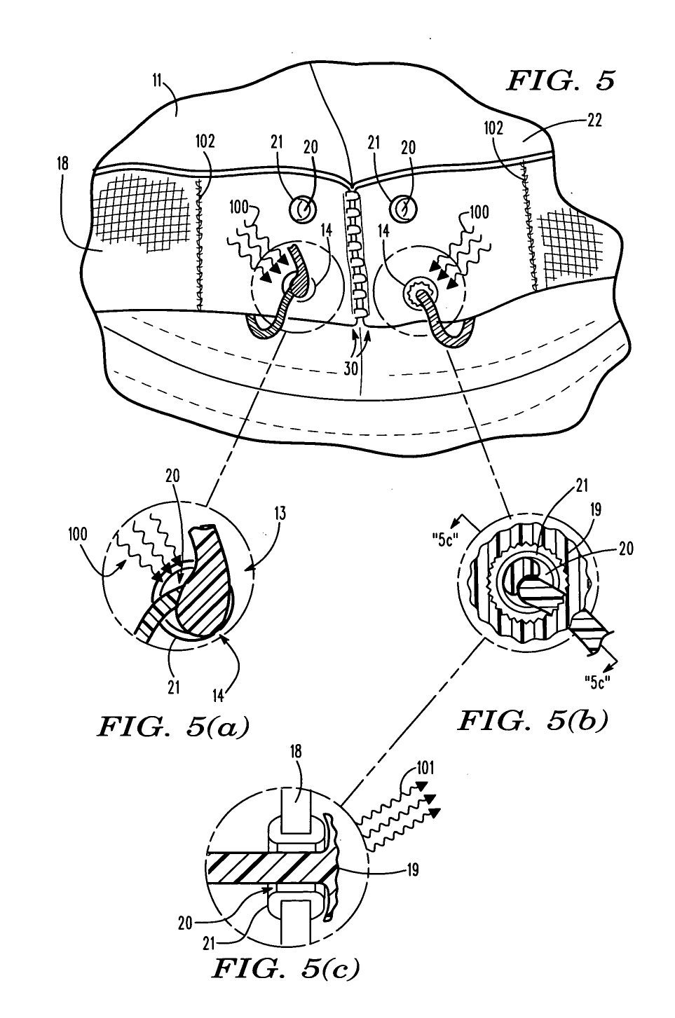

FIG. 5(a) attempts to depict the cord end 13 being softened into a liquefied globular state as at 14. FIGS. 5(b) and 5(c) attempt to depict the hardened, frozen, or solidified anchor 19, which anchor 19 comprises a width or diameter sufficient to anchor the cord end 13 to the hat band or foliage ring 18 of the hat construction 11 via the aperture structure formed therein. In this regard, FIGS. 5(b) and 5(c) depict apertures as at 20 formed in the hat band or foliage ring 18 of the hat construction 11, which apertures 20 extend through the thickness of the hat band or foliage ring 18. Preferably, the apertures 20 of the hat band or foliage ring 18 are outfitted with eyelets or grommets 21 or similar other relatively rigid structures for preventing the anchors 19 from passing through the apertures 20. FIG. 4 is a depiction of a grommet application device 31 and a hat assembly or hat construction 11 depicting a generic a grommet application device 31 applying eyelets or grommets 21 to the hat assembly 11 substantially as depicted.

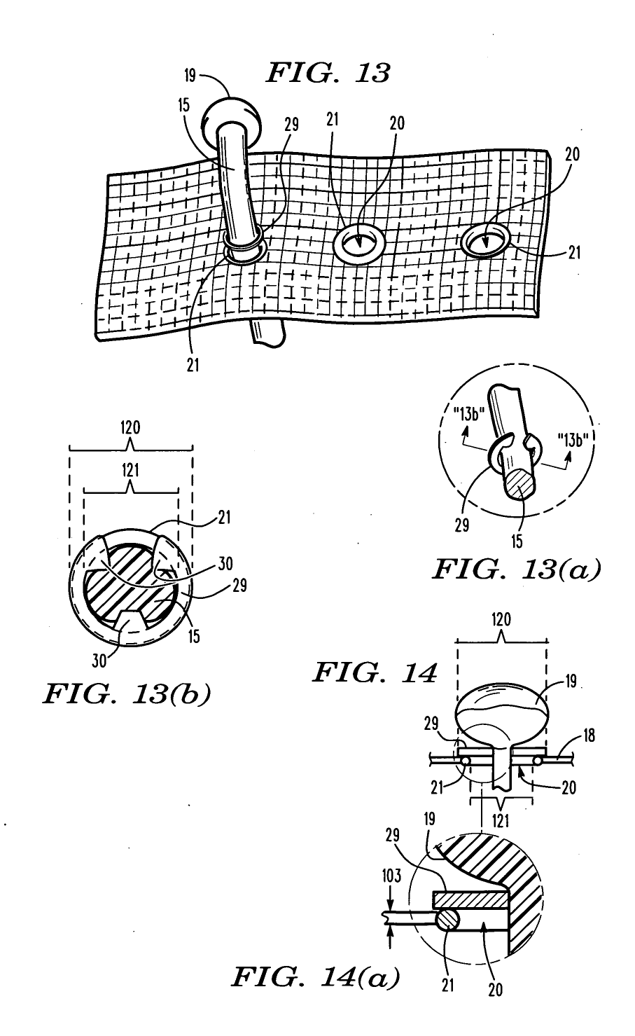

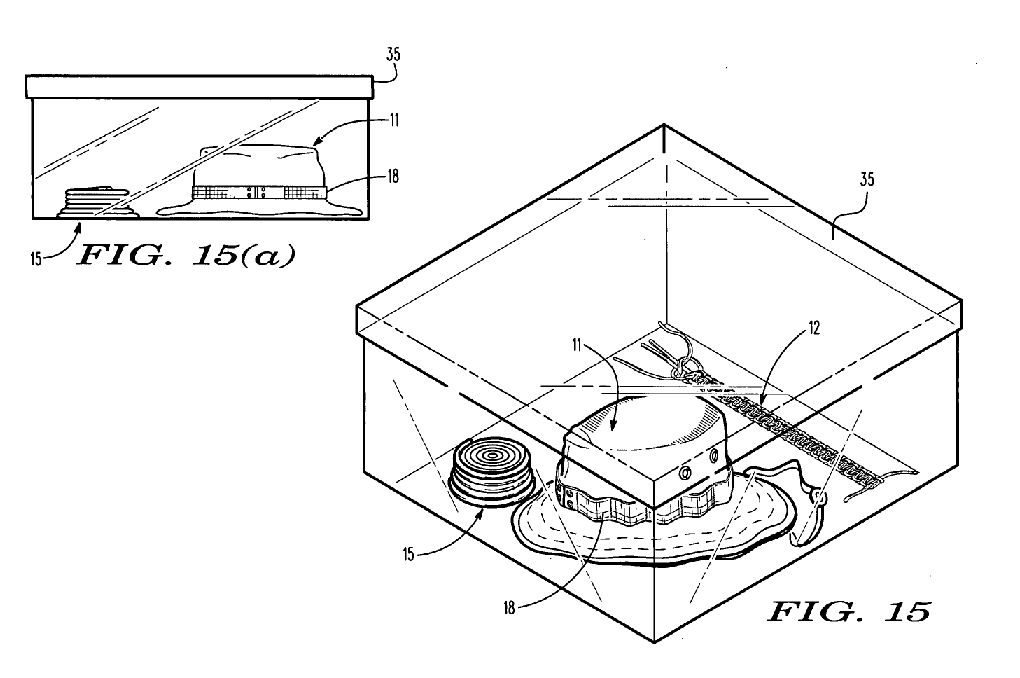

In this regard, it is contemplated that C-shaped crimp clamps or “C-clamps” 29 may also be outfitted upon the cord 15 adjacent the aperture structure 20 for enhancing the fastened attachment of the cord ends 13 to the hat band 18. It should be noted that the crimp clamps or C-clamps 29 are preferably formed from a rigid material and comprise an outer diameter 120 greater in magnitude than the inner diameter 121 of the grommets 21 for preventing the clamps 29 from passing through the grommets 21. Further, the clamps 29 preferably comprise inwardly radiating pointed structures as at 30, which structures or protrusions 30 pinch or crimp the cord 15 radially inward substantially as shown in FIG. 13(b). The protrusions 30 are believed to enhance the anchored attachment of the cord ends 13 to the apertures 20 of the band 18.

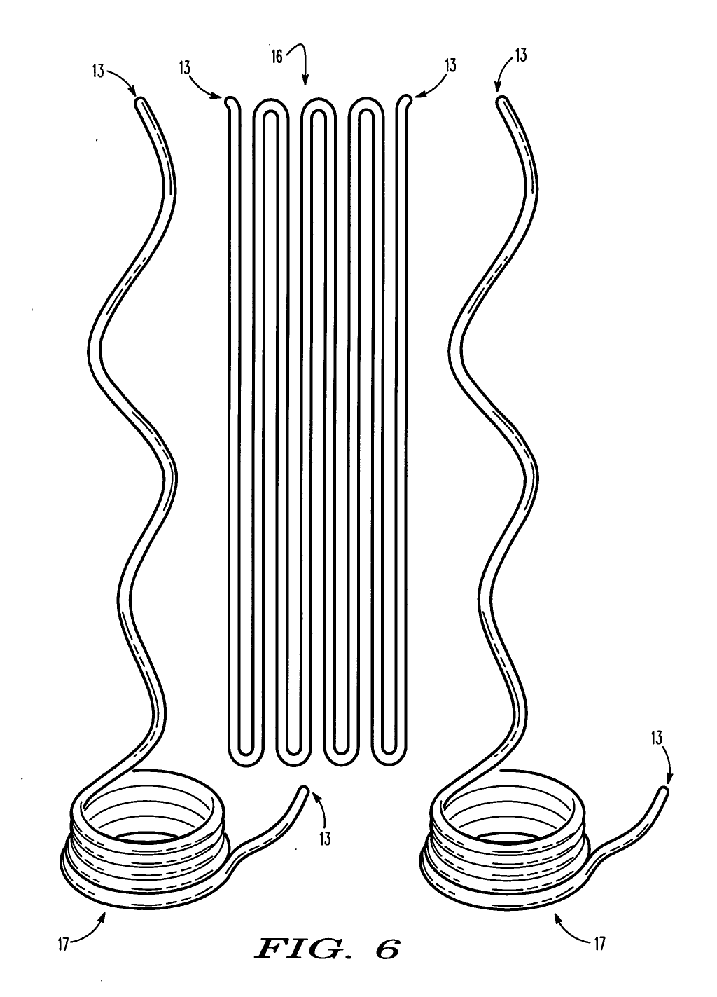

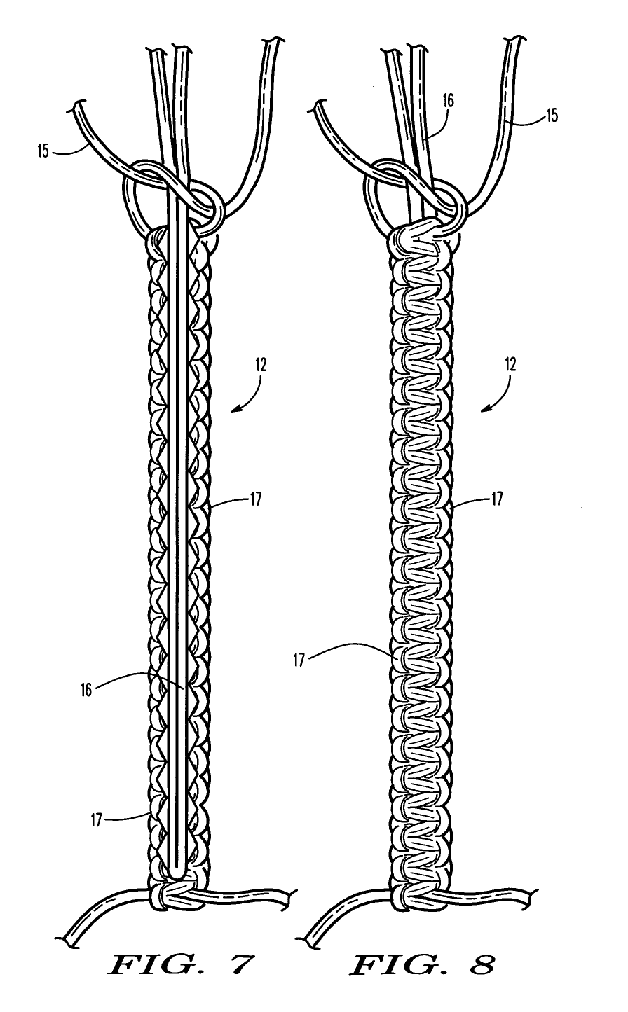

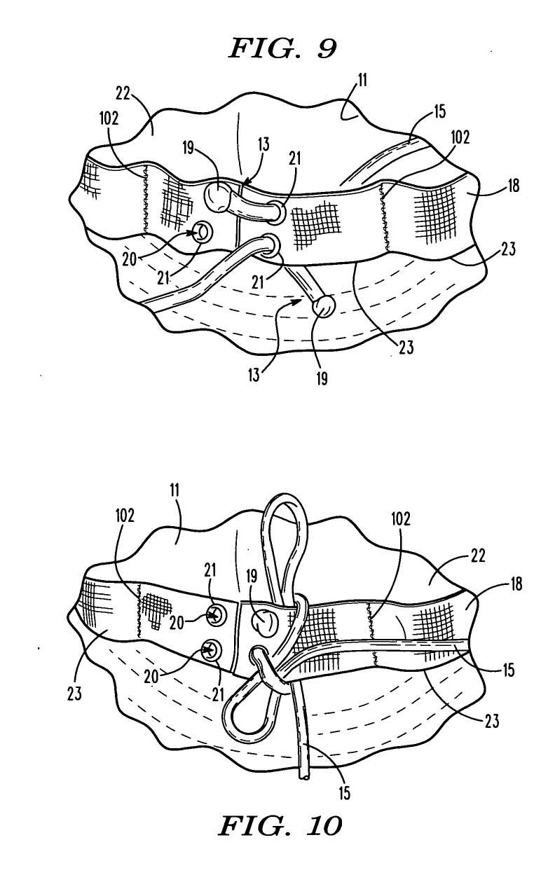

It is contemplated that the hat construction 11 may be formed from either flexible or rigid materials and that the braided cord 12 may be severed from the hat band or foliage ring 18 of the hat construction 11 (e.g. by way of a bladed element (not specifically shown). The length of cord 15 or lengths of cord are preferably attached to the hat construction 11 by way of the hat band or foliage ring 18, which ring or band 18 is periodically stitched as at 102 to the crown 22 of the hat construction widthwise across the ring or band 18 for forming periodic loops 23. The lengths of cord may then be wrapped around the band loops 23 and braided together as comparatively depicted in FIGS. 6-11.

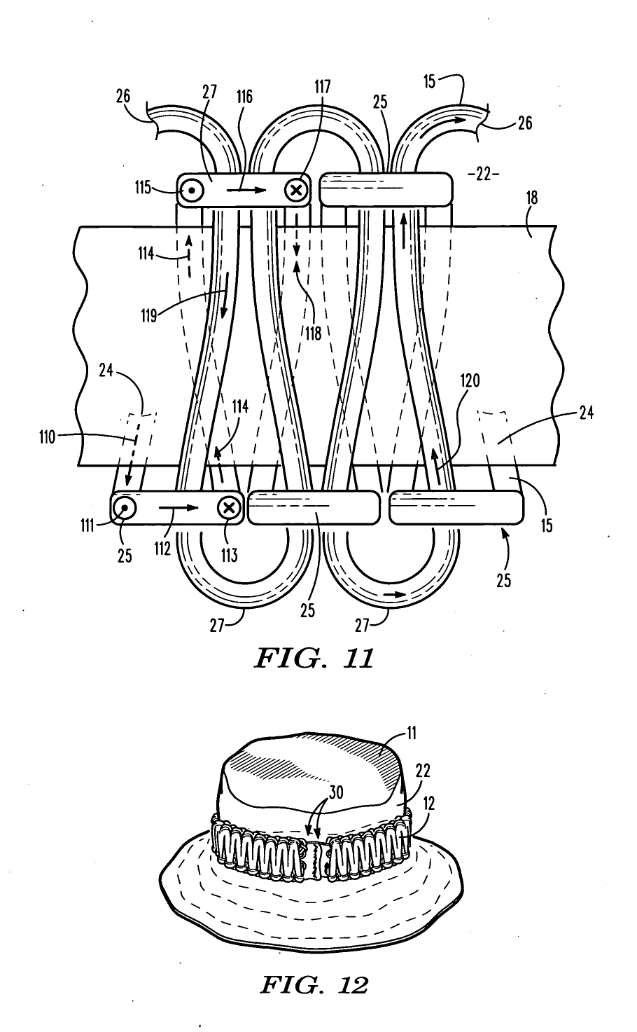

Referencing FIG. 11 it will be seen that a first cord at 24 primarily extends along the posterior or inward side of the hat band 18 but for forward loops 25 through which loops 25 a second cord 26 passes. The second cord 26 loops together the loops 25 via loops 27 substantially as shown. Cord 24 passes downward as at 110, then forward or outward as at 111, then rightward as at 112 then rearward or inward as at 113, then upward as at 114, then forward as at 115, then rightward as at 116, then rearward or inward downward as at 117, and then downward as at 118. The second cord 26 essentially is directed downward as at 119 and upward as at 120 via loops 27 to link to together with cord 24 via loops 25.

While the above description contains much specificity, this specificity should not be construed as limitations on the scope of the invention, but rather as an exemplification of the invention. For example, it is contemplated that the present invention essentially provides a hat-cord combination or assembly comprising a hat construction as at 11 and at least one length of cord as at 15 or at least one braided length of cord as at 12.

The hat construction 11 preferably comprises a crown portion as at 22 and a hat band as at 18. The hat band or foliage ring 18 preferably comprises a series of band loops as at 23, and at least one, but preferably two pair of apertures as at 20. The band loops 23 are periodically spaced about the circumference of the crown portion 22 and enable cord length to be fed through the loops between the band 18 and the crown portion intermediate stitching 102 for maximizing the overall length of the cord 15. Each cord-receiving aperture extends through the thickness 103 of the hat band 18 adjacent a terminal end 30 of the hat band 18.

Each length of cord 15 is preferably constructed from or comprises thermally-liquefiable material and has opposed primary cord ends as at 13. The primary cord ends 13 are insertable through the aperture structures 20 formed through the hat band 18 and are thermally-liquefiable for respectively liquefying the primary cord ends 13 at the aperture structure(s) 20. The liquefied primary cord ends 13 as at globules 14 are thermally-solidifiable for fastening the primary cord ends 13 to the hat band 18 at the aperture structure(s) 20 via solidified globule anchors 19. The hat-cord assembly 10 thus provides users with a hat construction 11 with a readily available, end-fastened length of cord 15.

The aperture structure of the hat band 18 may be defined by at least one pair of apertures, but preferably two pair of apertures, one pair being located at each band terminus with an upper aperture and a lower aperture. Such an arrangement enables effective attachment of at least two cords (of varying colors) so as to enhance the visual appearance of the braided arrangement. The primary cord ends 13 are attachable to the hat band 18 at the pair(s) of apertures 20.

Stated another way, the hat band 18 according to the present invention preferably comprises a first band end (as at 30), a second band end (as at 3), and a band length (e.g. 25-27 inches) intermediate said first and second band ends 30. The aperture structure(s) may be preferably defined by at least two pairs of apertures, whereby the first pair of apertures are adjacent the first band end and a second pair of apertures are adjacent the second band end. The length or lengths of cord 15 are extendable along the band length intermediate the first and second band ends 30 in any number of ways, but preferably as described and shown in this application.

For example, the length(s) of cord may preferably be braided for maximizing the effective cord length extendable along the band length intermediate the first and second band ends 30. A plurality of cord lengths may preferably be inter-braided for further maximizing the effective cord length extendable along the band length intermediate the first and second band ends 30. The cord length(s) preferably comprise a series of cord ends, which ends are thermally-liquefiable and thermally solidifiable for fastening the plurality of cord lengths to the hat construction 11 at the aperture structure(s).

The apertures 20 may preferably be outfitted with a grommet structure as at 21, which grommet structure is believed to enhance anchor attachment of the thermally solidifiable primary cord ends 13 or anchors 19. Further, each cord end 13 may be preferably outfitted with a crimp clamp 29 at the anchor site for enhancing anchor attachment of the thermally solidifiable primary cord ends 13 or anchors 19.

Still further, the foregoing specifications are believed to support kit-related aspects and certain methodology for assembling a hat-cord combination or utility gear assembly. In this last regard, it is contemplated that the hat-cord kit according to the present invention, as provided in a package 35, may well provided users with a hat construction 11 outfittable with a length of cord 15.

The method for assembling a hat-cord combination according to the present invention may be said to comprise the steps of: forming a hat construction as at 11, wherein the hat construction 11 comprises a crown-based hat band 18. The hat band 18 preferably comprises at least one aperture structure extending therethrough (preferably outfitted with grommets 21).

At least one length of cord 15 may then be provided, which length of cord 15 preferably comprises thermally-liquefiable material and has opposed primary cord ends. The primary cord ends may be extended through the aperture structure of the hat construction whereafter thermal energy may be directed into the primary cord ends thereby liquefying the thermally-liquefiable material at the primary cord ends.

The thermally liquefied material may then be solidified into globule like anchors 19 for fastening each length of cord to the hat band or foliage ring 18 at the aperture structure(s). The hat band 18 may preferably comprise a series of band loops, about and through which at least one length of cord may be cooperaably intertwined for outfitting the hat construction 11 with added length of cord. At least one outer braided length of cord may further envelope at least one inner length of cord before extending the primary cord ends through the aperture structure of the hat band 18. The method may further comprise the step of forming a hat construction 11 having at least one grommet-lined aperture. In other words, the method may comprise the step of forming at least one grommet-outfitted aperture structure as generally depicted in FIG. 4. As previously set forth, it is contemplated that the grommet structure 21 may well enhance anchor attachment of the thermally solidifiable primary cord ends 13 at anchors 19. Further, the crimp clamps 29 when attached to the cord ends 13 may also operate to enhance anchor attachment.

Accordingly, although the invention has been described by reference to certain preferred and alternative embodiments, and certain methodology, it is not intended that the novel disclosures herein presented be limited thereby, but that modifications thereof are intended to be included as falling within the broad scope and spirit of the foregoing disclosure, the following claims and the appended drawings.

I claim:

1. A hat-cord assembly for providing users with a combination hat construction and a length of cord, the hat-cord assembly comprising, in combination:
a hat construction, the hat construction comprising a crown portion and a hat band, the hat band preferably comprising a series of band loops and at least one aperture structure, the band loops being periodically spaced about the circumference of the crown portion, each cord-receiving aperture extending through the thickness of the hat band adjacent a terminal end of the hat band; and
at least one length of cord, the length of cord comprising thermally-liquefiable material and having opposed primary cord ends, the primary cord ends being insertable through the aperture structure and being thermally-liquefiable for respectively liquefying the primary cord ends at the aperture structure, the liquefied primary cord ends being thermally-solidifiable for fastening the primary cord ends to the hat band at the aperture structure, the hat-cord assembly thus for providing users with a hat construction and an end-fastened length of cord.

2. The hat-cord assembly of claim 1 wherein the aperture structure is defined by at least one pair of apertures, the primary cord ends being attachable to the hat band at the pair of apertures.

3. The hat-cord assembly of claim 2 wherein each pair of apertures and the primary cord ends are cooperably associated with select anchor enhancement means, the select anchor enhancement means being selected from the group consisting of a grommet structure and a crimp clamp, the select anchor enhancement means for enhancing anchor attachment of the thermally solidifiable primary cord ends.

4. The hat-cord assembly of claim 3 wherein the hat band comprises a first band end, a second band end, and a band length intermediate said first and second band sheath ends, said aperture structure being defined by at least two pairs of apertures, a first pair of apertures being adjacent the first band end and a second pair of apertures being adjacent the second band end, the length of cord being extendable along the band length intermediate the first and second band ends.

5. The hat-cord assembly of claim 4 wherein the length of cord is braided, the braided length of cord for maximizing the effective cord length extendable along the band length intermediate the first and second band ends.

6. The hat-cord assembly of claim 5 comprising a plurality of cord lengths, said cord lengths being interbraidable for further maximizing the effective cord length extendable along the band length intermediate the first and second band ends.

7. The hat-cord assembly of claim 6 wherein the plurality of cord lengths comprise a series of cord ends, the series of cord ends being thermally-liquefiable and thermally solidifiable for fastening the plurality of cord lengths to the hat construction at the aperture structure(s).

8. A hat-cord kit for providing users with a hat construction outfittable with a length of cord, the hat-cord kit comprising:
a hat construction, the hat construction comprising a crown portion and a hat band, the hat band preferably comprising a series of band loops and at least one aperture structure, the band loops being periodically spaced about the circumference of the crown portion, each cord-receiving aperture extending through the thickness of the hat band adjacent a terminal end of the hat band; and
at least one length of cord, the length of cord comprising thermally-liquefiable material and having opposed primary cord ends, the primary cord ends being insertable through the aperture structure and being thermally-liquefiable for respectively liquefying the primary cord ends at the aperture structure, the liquefied primary cord ends being thermally-solidifiable for fastening the primary cord ends to the hat band at the aperture structure, the hat-cord assembly thus for providing users with a hat construction and an end-fastened length of cord.

9. The hat-cord assembly of claim 1 wherein the aperture structure is defined by at least one pair of apertures, the primary cord ends being attachable to the hat band at the pair of apertures.

10. The hat-cord assembly of claim 2 wherein each pair of apertures and the primary cord ends are cooperably associated with select anchor enhancement means, the select anchor enhancement means being selected from the group consisting of a grommet structure and a crimp clamp, the select anchor enhancement means for enhancing anchor attachment of the thermally solidifiable primary cord ends.

11. The hat-cord assembly of claim 3 wherein the hat band comprises a first band end, a second band end, and a band length intermediate said first and second band sheath ends, said aperture structure being defined by at least two pairs of apertures, a first pair of apertures being adjacent the first band end and a second pair of apertures being adjacent the second band end, the length of cord being extendable along the band length intermediate the first and second band ends.

12. The hat-cord assembly of claim 4 wherein the length of cord is braided, the braided length of cord for maximizing the effective cord length extendable along the band length intermediate the first and second band ends.

13. The hat-cord assembly of claim 5 comprising a plurality of cord lengths, said cord lengths being interbraidable for further maximizing the effective cord length extendable along the band length intermediate the first and second band ends.

14. The hat-cord assembly of claim 6 wherein the plurality of cord lengths comprise a series of cord ends, the series of cord ends being thermally-liquefiable and thermally solidifiable for fastening the plurality of cord lengths to the hat construction at the aperture structure(s).

15. A method for assembling a hat-cord combination, said method comprising the steps of
forming a hat construction, the hat construction comprising a hat band, the hat band comprising at least one aperture structure extending therethrough;
providing at least one length of cord, the length of cord comprising thermally-liquefiable material and having opposed primary cord ends;
extending the primary cord ends through the aperture structure of the hat construction;
directing thermal energy into the primary cord ends thereby liquefying the thermally-liquefiable material at the primary cord ends; and
solidifying the thermally-liquefied material at the primary cord ends thereby fastening at least one length of cord to the hat band at the aperture structure.

16. The method of claim 15 wherein the hat band comprises a series of band loops, the at least one length of cord being cooperaably associated with the band loops for outfitting the hat construction with added length of cord.

17. The method of claim 16 wherein at least one outer braided length of cord envelopes at least one inner length of cord before extending the primary cord ends through the aperture structure of the hat band.

18. The method of claim 17 wherein the aperture structure comprises at least one pair of opposed apertures, the cord ends being attachable to the hat construction via the pair of opposed apertures.

19. The method of claim 18 wherein the hat band comprises first and second hat band ends and a band length intermediate said first and second band ends, said aperture structure being defined by at least two pairs of apertures, a first pair of apertures being adjacent the first band end and a second pair of apertures being adjacent the second band end, the length of cord being extended along the band length intermediate the first and second band ends before extending the primary cord ends through the aperture structure of the hat band.

20. The method of claim 15 wherein the step of forming a hat construction comprises the step of forming at least one grommet-outfitted aperture structure, the grommet structure for enhancing anchor attachment of the thermally solidifiable primary cord ends.
